(19) United States
(12) Patent Application Publication
(10) Pub. No.: US 2019/0235537 A1
(43) Pub. Date: Aug. 1, 2019

(54) DEVICE FOR THERMOSTATIC REGULATION OF A FLUID

(71) Applicant: VERNET, OLLAINVILLE (FR)

(72) Inventor: Emmanuel PLATET, LARDY (FR)

(73) Assignee: VERNET, OLLAINVILLE (FR)

(21) Appl. No.: 16/332,345

(22) PCT Filed: Sep. 13, 2017
(86) PCT No.: PCT/EP2017/073036

§ 371 Date: Mar. 11, 2019

(30) Foreign Application Priority Data
Sep. 14, 2016 (FR) 1658569

(51) Int. Cl. G05D 23/13

(52) U.S. Cl. CPC G05D 23/134

(57) ABSTRACT

A device for thermostatic regulation has a housing inside which a fluid flows. A thermostatic element that includes a heat-sensitive portion is in the path of fluid flow inside the housing. An actuated portion can move with respect to and under the effect of the heat-sensitive portion during heating of the heat-sensitive portion. A turbulator within the housing disturbs the flow of the fluid over the heat-sensitive portion. A passage for circulation of the fluid is defined between the heat-sensitive portion and a flexible portion of the turbulator. When at rest, the flexible portion throttles the cross-section of the flow passage, and under the effect of fluid flow in the passage, deforms in a resilient manner to vary the cross-section of the flow of the passage by moving away from the heat-sensitive portion depending on the flow rate of the fluid in the passage.

### PRIORITY AND CROSS REFERENCE TO RELATED APPLICATIONS

This application is the U.S. National Phase Application under 35 U.S.C. § 371 of International Application No. PCT/EP2017/073036, filed Sep. 13, 2017, designating the U.S. and published as WO 2018/050702 A1 on Mar. 22, 2018, which claims the benefit of French Application No. FR 1658569, filed Sep. 14, 2016. Any and all applications for which a foreign or a domestic priority is claimed is/are identified in the Application Data Sheet filed herewith and is/are hereby incorporated by reference in their entireties under 37 C.F.R. § 1.57.

### FIELD

The present invention relates to a thermostatic regulation device.

### SUMMARY

The present invention relates to a device for thermostatic regulation of a fluid.

### BRIEF DESCRIPTION OF THE DRAWINGS

The invention will be better understood upon reading the following description, provided solely as an example and done in reference to the drawings, in which:

FIG. 1 is a longitudinal sectional view of a first embodiment of a device according to the invention;

FIG. 2 is a perspective view of a longitudinal cross-section of only a portion of the device of FIG. 1;

FIG. 3 is a view similar to FIG. 1, illustrating the device of the latter in an operating state different from that illustrated in FIG. 1;

FIG. 4 is a longitudinal half-sectional view of a second embodiment of a device according to the invention;

FIG. 5 is a view similar to FIG. 2, illustrating a portion of the device of FIG. 4;

FIG. 6 is a view similar to FIG. 4, illustrating the device of the latter in an operating state different from that shown in FIG. 4; and

FIGS. 7 and 9 are views similar to FIGS. 4 to 6, respectively, illustrating a third embodiment of a device according to the invention.

### DETAILED DESCRIPTION

The present invention relates to a device for thermostatic regulation of a fluid. The invention applies to various fields of the thermal regulation of liquid fluids. Non-limitingly, the invention thus applies to the sanitation field, in particular for the regulation of mixed water resulting from the mixing of cold water and hot water. The invention also applies, inter alia, to the field of cooling/heating circuits, in which the circulation of a liquid is controlled as a function of the temperature of said liquid.

The invention more specifically examines the cases of thermostatic regulation, i.e., the cases where the heat of the fluid to be regulated is used to adjust the temperature of said fluid relative to an input value. To that end, the fluid to be regulated flows inside a housing and thermally stresses a heat-sensitive part of a thermostatic element there, said heat-sensitive part being designed so as, under the effect of its heating, to actuate the movement of an ad hoc part of the thermostatic element. The relative movement of the heat-sensitive part and the actuated part of the thermostatic element causes a regulation of the flow of fluid relative to the housing, by any closing and/or bypass member of the flow of fluid, one of the heat-sensitive and actuated parts of the thermostatic element commanding the movement of said member while the other of said heat-sensitive and actuated parts is connected to the housing. As an example, within a thermostatic cartridge for a sanitary tap, the mixed water resulting from the mixing of cold water and hot water is generally regulated by a slide valve controlling intakes of cold water and hot water inside the housing of the cartridge, said slide valve being driven relative to the housing by the heat-sensitive part of a thermostatic element, the position of the actuated part of which is commanded with respect to the housing by a mechanism for adjusting the temperature value around which the slide valve regulates the temperature of the mixed water. FR 2,821,411 provides an example of such a thermostatic cartridge.

In order for the thermostatic regulation of this type of device to be satisfactory, it is necessary for the fluid to communicate its heat effectively to the heat-sensitive part of the thermostatic element. In this perspective, it is known to use a turbulence-creating member, which is commonly called turbulator and an example of which is given in FR 2,821,411: this turbulator is arranged inside the housing of the thermostatic regulating device and surrounds the heat-sensitive part of the thermostatic element with an irregular surface that disrupts the flow of the fluid over said heat-sensitive part so as to increase the turbulence of said flow, to homogenize the temperature with which the fluid stresses the heat-sensitive part, and also to increase the local speed of said flow on the surface of the heat-sensitive part to promote thermal exchanges.

However, due to its fixed and fairly massive presence, such a turbulator restricts the passage section around the heat-sensitive part and therefore imposes a limitation on the maximum flow rate of fluid through the thermostatic regulating device. Conversely, when the fluid passes through the device with a low flow rate, the turbulator may have only a marginal effect on the flow of the fluid, without guaranteeing that the fluid has a homogeneous temperature, or that it flows over the heat-sensitive part of the thermostatic element. In other words, the dimensioning of the turbulator results from a compromise between the maximum admissible flow rate and the expected thermostatic regulation at a low flow rate.

The aim of the present invention is to propose a thermostatic regulating device, which reconciles a high value of its maximum acceptable flow rate and a good performance of its thermostatic regulation at a low flow rate.

To that end, the invention relates to a device for the thermostatic regulation of a fluid comprising:
a housing, inside which a fluid flows,
a thermostatic element, which includes a heat-sensitive portion, situated in a flow of the fluid inside the housing, and an actuated portion, movable relative to the heat-sensitive portion by the heat-sensitive portion during heating of the heat-sensitive portion, and
a turbulator, which is carried by the housing so as to disturb a flow of the fluid over the heat-sensitive portion.

A passage for circulating the fluid is delimited between the heat-sensitive portion of the thermostatic element and a flexible portion of the turbulator, said flexible portion being designed so as:
when at rest, to throttle a flow section of the passage, and
under a flow of the fluid in the passage, to deform in a resilient manner in order to vary the flow section of the passage by moving away from the heat-sensitive portion as a function of flow rate of the fluid in the passage.

One of the ideas at the base of the invention is to modify the functional form of the turbulator as a function of the flow rate. To that end, the turbulator of the device according to the invention includes a flexible portion, arranged so as to delimit a fluid circulation passage between the latter and the heat-sensitive portion of the thermostatic element. When the flow rate of the fluid to be regulated is low, the flexible portion of the turbulator occupies a configuration close to that which it occupies when at rest: in this configuration, the flexible portion grips the aforementioned passage, locally throttling the flow passage of the latter, and therefore forces the fluid to flow against the heat-sensitive portion so as to best sensitize the latter. When the flow rate of the fluid increases, the flow of the fluid deforms the flexible portion of the turbulator, moving it locally away from the heat-sensitive portion: the flow section of the aforementioned passage therefore increases, the resiliency of the flexible portion, which allows this deformation, also making it possible to maintain the flow of the fluid against the heat-sensitive portion. At a very high flow rate, the flexible portion of the turbulator reaches a maximum deformed configuration, which maximally opens the aforementioned passage, freeing its passage section. Thus, owing to the resiliency of the flexible portion of the turbulator, the flow section of the passage delimited between said flexible portion and the heat-sensitive portion of the thermostatic element varies as a function of the flow rate of the fluid in said passage, while increasing when the flow rate increases and decreasing when the flow rate decreases, for a flow rate range from zero to a maximum acceptable flow rate value, not limited by the turbulator, for the device.

In practice, the flexible portion of the turbulator can have quite varied embodiments and/or component materials, provided the flexible portion adjusts its deformation state resiliently to the flow rate of the fluid in a passage delimited between it and the heat-sensitive portion of the thermostatic element, in order to best sensitize said heat-sensitive portion. Thus, according to additional features of the device:
The flexible portion includes elements movable relative to the rest of the turbulator, which are situated on the flow of the fluid inside the housing, while being distributed around the heat-sensitive portion, and which arrange free circulation spaces between them for the fluid, the flow section of which is independent of deformation state of said elements.
Each of said elements of the flexible portion has an elongate shape that, irrespective of deformation state of the flexible portion, extends lengthwise substantially along the flow of the fluid over the heat-sensitive portion.
Each of said elements of the flexible portion has an elongate shape that, when at rest, extends lengthwise substantially perpendicular to the flow of the fluid over the heat-sensitive portion.
The flexible portion includes a wall movable relative to the rest of the turbulator, which is situated over the flow of the fluid inside the housing, running continuously all around the heat-sensitive portion.
Said wall of the flexible portion has a globally tubular elongate shape that, irrespective of deformation state of the flexible portion, extends lengthwise along the flow of the fluid over the heat-sensitive portion.
The turbulator includes a rigid support for supporting the flexible portion, said rigid support being suitable for assembling the turbulator to the housing.
The flexible portion includes a base that is carried fixedly by the rigid support, the rest of the flexible portion being freely deformable with respect to the rigid support.
The flexible portion includes two bases, which are each carried fixedly by the rigid support, the rest of the flexible portion connecting the bases to one another and being freely deformable with respect to the rigid support.
The flexible portion consists of said elements of the flexible portion.
The heat-sensitive portion and the actuated portion of the thermostatic element are movable relative to one another in translation along an axis, the heat-sensitive portion and the flexible portion are substantially centered on said axis, and the flow section of the passage varies radially to said axis during deformation of the flexible portion.

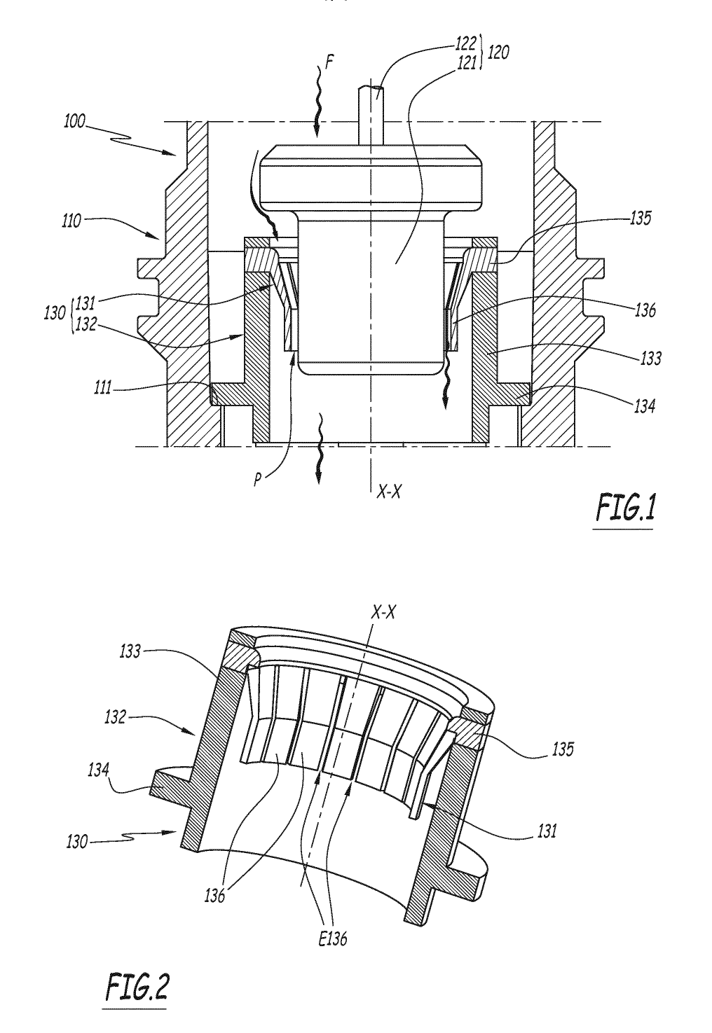

FIGS. 1 to 3 show a device 100 for thermostatic regulation of a liquid fluid F such as water, a heat transfer liquid, a refrigerant, etc. By way of non-limiting exemplary application, the device 100 is incorporated into a thermostatic cartridge of a sanitary tap, making it possible to regulate the temperature of the mixed water leaving the cartridge, obtained by mixing hot water and cold water allowed at the inlet of the cartridge.

As clearly shown in FIG. 1, the device 100 includes a housing 110 inside which the fluid F is provided to flow. In the exemplary embodiment considered in the figures, the housing 110 has, at least for its portion considered in the figures, a globally tubular shape, which is centered on a geometric axis X-X and which is open at both of its opposite axial ends: the fluid is provided to enter inside the housing 110 through one of the aforementioned ends, namely that facing upward in FIG. 1, and to leave the housing through the other end, i.e., that facing downward in FIG. 1. Of course, other geometric shapes can be considered for the housing 110 as long as the latter inwardly delimits a flow path for the fluid F.

The device 100 also includes a thermostatic element 120 that is at least partially arranged inside the housing 110. More specifically, the thermostatic element 120 comprises a heat-sensitive portion 121, which is situated on the flow of the fluid F inside the housing 110, and an actuated portion 122 that is movable relative to the heat-sensitive portion 121, in particular in translation parallel to the axis X-X, under the effect of the heat-sensitive portion 121 during the heating of the latter. According to one preferred but non-limiting embodiment, the heat-sensitive portion 121 primarily includes a cup, typically metal, that is centered on the axis X-X and that contains a thermodilatable material, typically wax-based, while the actuated part 122 globally forms a piston, also centered on the axis X-X and plunging inside the aforementioned cup, such that, during the heating of the cup, the thermodilatable material that it contains expands and thus pushes the aforementioned piston to deploy the latter along the axis X-X relative to the cup. That being said, other embodiments can be considered for the thermostatic element 120, such as an actuator with a heat-sensitive portion made from a shape memory alloy.

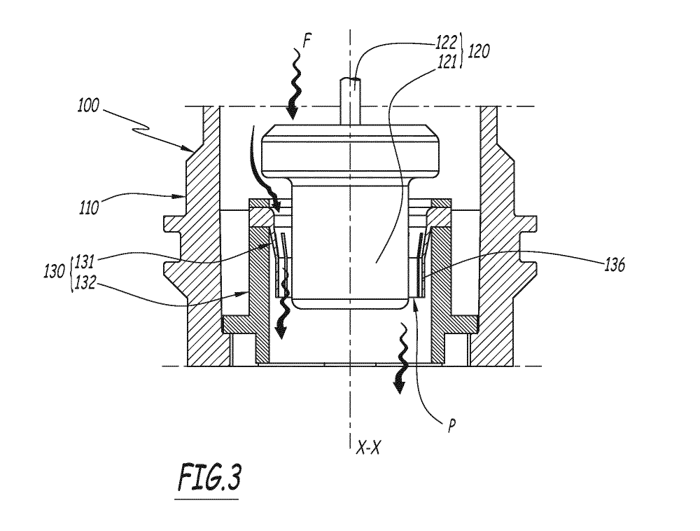

The device 100 further includes a turbulator 130, which is assembled to the rest of the device 100 in FIGS. 1 and 3 and which is shown alone in FIG. 2. In the assembled state of the device 100, the turbulator 130 is carried by the housing 110 so as to disturb the flow of the fluid F on the heat-sensitive portion 121 of the thermostatic element 120.

As clearly shown in FIG. 2, the turbulator 130 includes a flexible portion 131 and a rigid support 132 that both supports the flexible portion 131 and makes it possible to assemble the turbulator 130 to the housing 110. In the exemplary embodiment considered here, the support 132 primarily includes a bushing 133 having a tubular shape, centered on a geometric axis that, in the assembled state of the device 100, is combined with the axis X-X. The bushing 133 is provided with an outer peripheral collar 134 provided to participate in the assembly of the turbulator 130 to the housing 110: as shown in FIG. 1, in the assembled state of the device 100, the bushing 133 is mounted coaxially inside the housing 110 such that the collar 134 bears axially against an inner shoulder 111 of the housing. Of course, other embodiments can be considered for the developments of the support 132 that allow the assembly of the turbulator 130 to the housing 110.

As clearly shown in FIG. 2, the flexible portion 131 of the turbulator 130 includes a base 135, which has a globally annular shape and which is fixedly secured to the bushing 133 of the support 132, by any appropriate means. By way of non-limiting examples, the base 135 is co-injected with the bushing 133 or attached to the latter by gluing, welding, shape assembly, addition of junction parts, etc. In all cases, within the turbulator 130, the base 135 is fixedly carried by the support 132.

Also as clearly shown in FIG. 2, the flexible portion 131 includes a plurality of elements 136, each of said elements 136 extending from the base 135 to the inside of the bushing 133 of the support 132. By resilient deformation of the elements 136, as well as the junction zone between said elements and the base 135, the elements 136 are movable relative to the base 135, and thus to the support 132, in other words movable relative to the rest of the turbulator 130. Within the turbulator 130, the flexible portion 131 is thus fixedly connected to the support 132 by its base 135, while its elements 136 are freely deformable relative to the support 132.

In the embodiment considered in FIG. 2, the elements 136 are distributed, advantageously regularly, on the periphery of the base 135, while arranging free spaces E136 between them that separate each element 136 from its two adjacent elements 136 and that thus make the elements 136 distinct from one another. As a result, each of the elements 136 is movable relative to the rest of the turbulator 130 independently of the other elements 136. Furthermore, each of the elements 136 extends from the base 135 while having an elongate shape: when the flexible portion 131 is at rest, i.e., when no outside stress is exerted on the flexible portion 131, like in FIG. 2, the elongate shape of the elements 136 extends lengthwise globally parallel to the axis X-X, at least for a portion of these elements 136, in particular their end portion opposite their junction zone with the base 135.

In the assembled state of the device 100 like in FIGS. 1 and 3, the flexible portion 131 is arranged at the axial level of the heat-sensitive portion 121 of the thermostatic element 120, while surrounding said heat-sensitive portion 121. A passage P for the circulation of the fluid F is thus delimited radially between the heat-sensitive portion 121 and the flexible portion 131, in particular the elements 136 of the latter. The elements 136 being distributed around the heat-sensitive portion 121, the passage P is formed, at the axial level of these elements 136, by a plurality of ring portions, each of said ring portions being defined radially between the heat-sensitive portion 121 and one of the elements 136. At its opposite axial ends, the passage P communicates freely with the rest of the inside of the housing 110, such that when the fluid F flows inside the housing, said flow passes through the turbulator 130 while passing at least partially through the passage P, as indicated schematically by the arrows in FIG. 1. As a result, in the same manner as for the heat-sensitive portion 121, the elements 136 of the flexible portion 131 are situated in the flow of the fluid F inside the housing 110, while being subject to the effect of the pressure resulting from the flow of the fluid F in the passage P, as outlined hereinafter.

When there is no flow of the fluid F inside the housing 110, the flexible portion 131 stays at rest, typically in its configuration shown in FIG. 2. In this configuration at rest, the elements 136 are arranged radially in the immediate vicinity of the heat-sensitive portion 121, or even locally in contact with said heat-sensitive portion 121. The elements 136 thus throttle the flow section of the passage P, by narrowing or even completely closing said passage P.

When fluid F flows inside the housing 110 like in FIGS. 1 and 3, said fluid flows in the passage P and, under the effect of said flow, resiliently deforms the flexible portion 131, in particular by radially separating the elements 136 from the heat-sensitive portion 121. Compared to the configuration at rest, the flow section of the passage P increases. It is understood that when the flow rate of the fluid F supplying the housing 110 is low, as shown schematically in FIG. 1, the flexible portion 131 is deformed, but with a deformed configuration that is close, or even practically similar to its configuration at rest, due to the fact that the pressure effect resulting from the flow of this low flow rate causes only a limited or practically nonexistent deformation of the flexible portion 131, in particular by only marginally, or not at all moving the elements 136 compared to the position that they occupy in the at-rest configuration of the flexible portion 131. Conversely, when the flow rate of the fluid supplying the housing 110 is greater, i.e., strong, or even equal to the maximum flow rate acceptable by the device 100, as schematically indicated in FIG. 3, the effect of said flow in the passage P causes a substantial deformation of the flexible portion 131: in particular, the elements 136 are moved away from the heat-sensitive portion 121 more than when the flow rate is low, the longitudinal direction of the elements 136 remaining advantageously substantially parallel to the flow direction of the fluid over the heat-sensitive portion 121.

It is understood that the intensity of the deformation of the flexible portion 131 depends directly on the value of the flow rate of the fluid F in the passage P, the deformed state of the flexible portion 131 adjusting by resiliency to the value of said flow rate: thus, as a function of the flow rate of the fluid F in the passage P, the flow section of the passage P varies by corresponding resilient deformation of the flexible portion 131, in particular by radial separation of the elements 136 with respect to the heat-sensitive portion 121. In practice, in light of the centering of the heat-sensitive portion 121 and the flexible portion 131 on the axis X-X, the variation of the flow section of the passage P is thus done radially to said axis X-X.

It results from the preceding explanations that the flexible portion 131, in particular its elements 136, force the fluid F circulating in the passage P to flow over the heat-sensitive portion 121, channeling said flow against the heat-sensitive portion 121, irrespective of the value of the flow rate of said fluid. This arrangement is of notable interest when the flow rate of the fluid F is low, since despite the small quantity of fluid introduced inside the housing 110, the heat-sensitive portion 121 is best thermally stressed by said fluid. This advantage does not handicap the ability of the device 100 to be able to admit a high maximum flow rate, in that when the fluid F supplies the housing 110 with a high flow rate, the flexible portion 131 does not significantly hinder the circulation of the fluid, subject to the increase of the flow section of the passage P by deformation of the elements 136. In light of the fact that the elongate shape of the elements 136 extends lengthwise substantially in the flow direction of the fluid over the heat-sensitive portion 121 irrespective of the deformation state of the elements 136, the channeling of the fluid F over the heat-sensitive portion 121 is advantageously maintained over a substantial axial expanse of the latter, thus reinforcing its thermal stressing by the fluid F.

In all cases, the turbulator 130, in particular its flexible portion 131, disturbs the flow of the fluid inside the housing 110, by creating turbulence therein, particularly at the heat-sensitive portion 121, which homogenizes the temperature of the fluid in the passage P and favors the transfer of heat therein between said fluid and the heat-sensitive portion 121.

Furthermore, in particular to avoid any overly pronounced pressure differential axially on either side of the elements 136, the free spaces E136 arranged between these elements in a direction peripheral to the axis X-X allow the fluid F to circulate freely axially through the flexible portion 131 since, unlike the flow section of the passage P, the flow section of the free spaces E136 is independent of the deformation state of the elements 136.

In light of the fact that the elongate shape of the elements 136 extends lengthwise substantially in the flow direction of the fluid over the heat-sensitive portion 121, the channeling of the fluid F over the heat-sensitive portion 121 is advantageously maintained over a substantial axial expanse of the latter, thus reinforcing its thermal stressing by the fluid F.

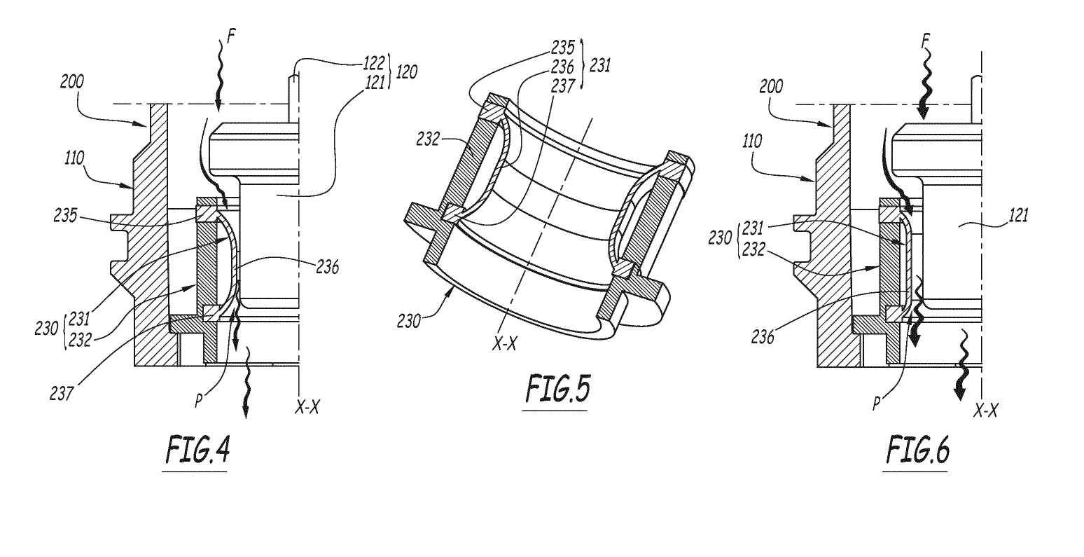

FIGS. 4 to 6 show a device 200 for thermostatic regulation of a fluid F. This device 200 has the same functional purpose as the device 100 and includes a housing and a thermostatic element that are identical to the housing 110 and the thermostatic element 120 of the device 100, such that the housing and the thermostatic element of the device 200 are respectively referenced 110 and 120 hereinafter.

The device 200 differs from the device 100 by its turbulator 230. More specifically, the turbulator 230 includes a flexible portion 231 and a support 232, which are functionally similar to the flexible portion 131 and the support 132 of the turbulator 130. In the example embodiment considered in FIGS. 4 to 6, the support 232 is even practically identical to the support 132. Conversely, the flexible portion 231 differs from the flexible portion 131 in several respects.

Indeed, the flexible portion 231 includes not one, but two bases 235 and 237. Each of said bases 235 and 237 is fixedly carried by the support 232, similarly to the base 135 with respect to the support 132. Furthermore, the bases 235 and 237 are connected to one another by a wall 236 of the flexible portion 231: this wall 236 thus extends from the bases 235 and 237, inside the support 232, while being freely deformable relative to said support 232, as clearly shown in FIG. 5. By resilient deformation of the wall 236 and junction zones between the latter and the bases 235 and 237, the wall 236 is movable relative to the rest of the turbulator 230.

In the assembled state of the device 200, the wall 236 runs continuously all the way around the heat-sensitive portion 121 of the thermostatic element 120, as clearly shown in FIGS. 4 and 6: the passage axially delimited between the heat-sensitive portion 121 and the flexible portion 231 forms, at the wall 236, a continuous crown, by which all of the fluid F is forced to circulate to pass between the opposite axial ends of the flexible portion 231, in particular without being able to circulate freely through openings in the wall 236, such as the free spaces E136 of the flexible portion 131 of the turbulator 130.

Functionally similarly to the elements 136 of the flexible portion 131, the wall 236 is situated on the flow of the fluid F inside the housing 110: under the effect of the flow of the fluid in the passage P, the flexible portion 231 deforms resiliently in order to vary the flow section of the passage P, in particular by separating the wall 236 with respect to the heat-sensitive portion 121. When the flexible portion 231 is at rest like in FIG. 5, the wall 236 throttles the flow section of the passage P, while as a function of the flow rate of the fluid F in the passage P when fluid circulates in the housing 110, the flow section of the passage P varies, the deformation of the flexible portion 231 being minimal when the flow rate of the fluid is low like in FIG. 4, whereas it is high when the flow rate of the fluid is strong like in FIG. 6.

Advantageously, the wall 236 has a globally tubular elongate shape that, irrespective of the deformation state of said wall 236, extends lengthwise in the flow direction of the fluid over the heat-sensitive portion 121: in this way, the wall 236 forces the flow of the fluid F in the passage P over a substantial axial expanse of the heat-sensitive portion 121.

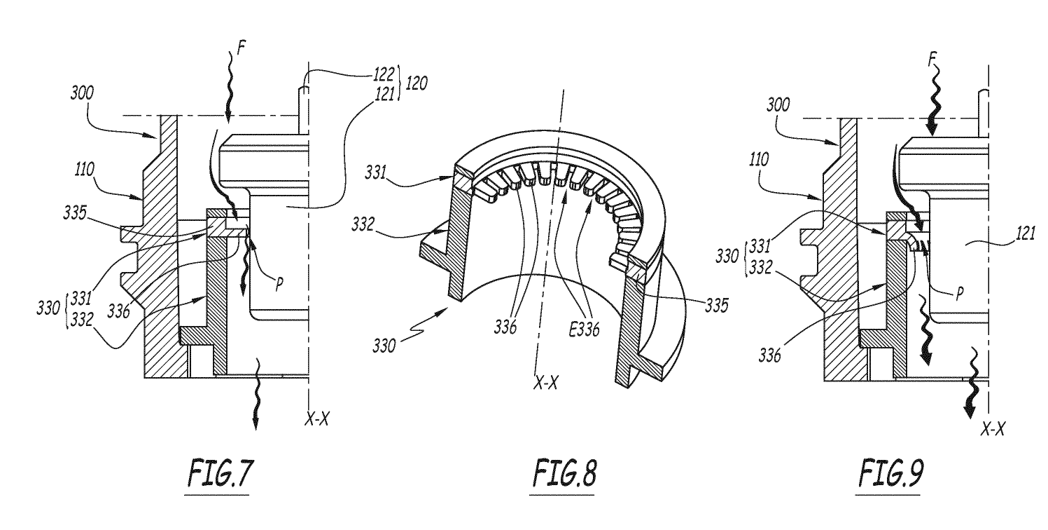

FIGS. 7 to 9 show a device 300 for thermostatic regulation of a fluid F. The device 300 has the same functional purpose as the devices 100 and 200. Furthermore, the device 300 includes a housing and a thermostatic element that are identical to those of the devices 100 and 200, such that the housing and the thermostatic element of the device 300 are referenced 110 and 120 hereinafter.

The device 300 differs from the devices 100 and 200 by its turbulator 330, which, although it has the same functional purpose, is structurally different from the turbulators 130 and 230. More specifically, the turbulator 330 includes a flexible portion 331 and a support 332. In the example embodiment considered in FIGS. 7 to 9, the support 332 is identical to the support 132 of the turbulator 130. Furthermore, the flexible portion 331 includes, similarly to the flexible portion 131, a base 335 from which elements 336 extend, distributed along the periphery of the base 335 and arranging free spaces E336 between them that are functionally similar to the free spaces E136 associated with the flexible portion 131.

The elements 336 of the turbulator 330 differ from the elements 136 of the turbulator 130 by their geometric shape, in that, although the elements 336 each have an elongate shape, the latter extends lengthwise in a direction that, when the flexible portion 331 is at rest, is substantially perpendicular to the flow direction of the fluid F over the heat-sensitive portion 121, as clearly shown in FIGS. 7 and 8. Thus, the passage P, delimited between the heat-sensitive portion 121 and the flexible portion 331, has a flow section that on the one hand is throttled by the flexible portion 331, in particular its elements 336, when said flexible portion is at rest, and on the other hand, varies as a function of the flow rate of the fluid F when the latter flows in the housing 110, by resilient deformation of the flexible portion 331, in particular by separation of the elements 336 with respect to the heat-sensitive portion 121 subject to the curvature of the longitudinal direction of the elements 336 under the effect of the flow of the fluid, as clearly shown by comparison between FIG. 7, which illustrates the circulation of the fluid F with a low flow rate, and FIG. 9, which illustrates the circulation of the fluid F with a strong flow rate. While offering the benefit of varying the flow section of the passage P, the flexible portion 331 of the turbulator 330 is particularly compact.

The devices 100, 200 and 300 provide an overview of the multiplicity of embodiments that the thermostatic regulating device according to the invention may assume, in particular regarding its turbulator. In particular, as illustrated by the flexible portions 131, 231 and 331, the structural or geometric specifications of the flexible portion of the device according to the invention can be varied, without being limited to those described thus far and shown in the figures. The same is true for the component material of said flexible portion: this material can in particular be rubber, but various other materials imparting the necessary resilient flexibility to the operation of the turbulator can be considered.

Lastly, all or some of the features of each embodiment can be implemented, as a replacement or in combination, in the other embodiments, as long as doing so is technically possible.

1.-14. (canceled)

15. A device for thermostatic regulation of a fluid, comprising:
a housing, inside which a fluid flows,
a thermostatic element, which includes a heat-sensitive portion, situated in a flow of the fluid inside the housing, and an actuated portion, movable relative to the heat-sensitive portion by the heat-sensitive portion during heating of the heat-sensitive portion, and
a turbulator, which is carried by the housing so as to disturb a flow of the fluid over the heat-sensitive portion,
wherein a passage for circulating the fluid is delimited between the heat-sensitive portion of the thermostatic element and a flexible portion of the turbulator, said flexible portion being designed so as:
when at rest, to throttle a flow section of the passage, and
under a flow of the fluid in the passage, to deform in a resilient manner in order to vary the flow section of the passage by moving away from the heat-sensitive portion as a function of flow rate of the fluid in the passage.

16. The device according to claim 15, wherein the flexible portion includes elements movable relative to the rest of the turbulator, which are situated on the flow of the fluid inside the housing, while being distributed around the heat-sensitive portion, and which arrange free circulation spaces between them for the fluid, the flow section of which is independent of deformation state of said elements.

17. The device according to claim 16, wherein each of said elements of the flexible portion has an elongate shape that, irrespective of deformation state of the flexible portion, extends lengthwise along the flow of the fluid over the heat-sensitive portion.

18. The device according to claim 16, wherein each of said elements of the flexible portion has an elongate shape that, when at rest, extends lengthwise perpendicular to the flow of the fluid over the heat-sensitive portion.

19. The device according to claim 15, wherein the flexible portion includes a wall movable relative to the rest of the turbulator, which is situated over the flow of the fluid inside the housing, running continuously all around the heat-sensitive portion.

20. The device according to claim 19, wherein said wall of the flexible portion has a globally tubular elongate shape that, irrespective of deformation state of the flexible portion, extends lengthwise along the flow of the fluid over the heat-sensitive portion.

21. The device according to claim 15, wherein the turbulator includes a rigid support for supporting the flexible portion, said rigid support being suitable for assembling the turbulator to the housing.

22. The device according to claim 21, wherein the flexible portion includes a base that is carried fixedly by the rigid support, the rest of the flexible portion being freely deformable with respect to the rigid support.

23. The device according to claim 21, wherein the flexible portion includes two bases, which are each carried fixedly by the rigid support, the rest of the flexible portion connecting the bases to one another and being freely deformable with respect to the rigid support.

24. The device according to claim 16, wherein the flexible portion consists of said elements of the flexible portion.

25. The device according to claim 24, wherein the turbulator includes a rigid support for supporting the flexible portion, said rigid support being suitable for assembling the turbulator to the housing.

26. The device according to claim 19, wherein the flexible portion consists of said wall of the flexible portion.

27. The device according to claim 26, wherein the turbulator includes a rigid support for supporting the flexible portion, said rigid support being suitable for assembling the turbulator to the housing.

28. The device according to claim 15, wherein the heat-sensitive portion and the actuated portion of the thermostatic element are movable relative to one another in translation along an axis, wherein the heat-sensitive portion and the flexible portion are substantially centered on said axis, and wherein the flow section of the passage varies radially to said axis during deformation of the flexible portion.
